(19) United States
(12) Patent Application Publication
(10) Pub. No.: US 2007/0095405 A1
(43) Pub. Date: May 3, 2007

(54) Check valve

(76) Inventors: Uwe Nigrin, Ilmenau (DE); Ngoc-Tam Vu, Ludwigsburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/570,091

(22) PCT Filed: May 13, 2005
(86) PCT No.: PCT/EP05/52213

§ 371 Date: Mar. 1, 2006

(30) Foreign Application Priority Data
Jun. 9, 2004 (DE) 10 2004 028 073.8

(51) Int. Cl. F16K 15/06

(52) U.S. Cl. 137/541

(57) ABSTRACT

The invention relates to a check valve comprising a valve body (1) provided with a valve seat (2) formed in the valve body (1), a valve plunger (4) which is guided in a guiding borehole (3) of the valve body (1), and a valve disk (5) which is embodied on the valve plunger (4) and can be applied to the valve seat (2) arranged in the valve body (1) in a sealing manner. The admission (6, 7) to the check valve (1) is carried out by means of at least one supply groove (6) embodied in the front side (8) of the valve body (1), opposing the valve seat (2), and at least one supply borehole (7) formed in the valve body (1). The inventive check valve (20) is especially suitable for a radial piston pump for the high-pressure supply of fuel in fuel injection systems of internal combustion engines.

### CROSS-REFERENCE TO RELATED APPLICATIONS

This application is a U.S. national stage application of International Application No. PCT/EP2005/052213 filed Mar. 13, 2005, which designates the United States of America, and claims priority to German application number DE 10 2004 028 073.8 filed Jun. 9, 2004, the contents of which are hereby incorporated by reference in their entirety.

### TECHNICAL FIELD

The invention relates to a check valve in accordance with the preamble of patent claim 1 as well as to a radial reciprocating pump for high-pressure fuel injection systems of internal combustion engines with such a check valve.

### BACKGROUND

Generic check valves are used for example as intake valves in radial reciprocating pumps for high-pressure fuel supply. Such an arrangement is known for example from EP 0 925 446 B1. The check valve in this case features a number of radial supply boreholes which open out inwards into a plunger through-opening. The plunger through-opening widens somewhat in the area of the supply hole exit so that when the check valve is open fuel can get past the plunger into the compressor area of the pump. The disadvantage of such a solution however is that the widened area interrupts the guidance of the valve plunger in the plunger through-opening. This means that the check valve provides only a small guidance surface for the valve plunger.

The valve body is also weakened in an axial direction by the radial feed boreholes. This can cause the valve body to warp, especially during installation.

The radial supply boreholes also require a great deal of effort to deburr, which increases the outlay for manufacturing the check valve.

### SUMMARY

Using the prior art as its starting point, the object of the present invention is to produce a check valve which guarantees the greatest possible valve plunger guidance, has a robust valve body and is simple to manufacture.

The object can be achieved by a check valve comprising a valve body with a valve seat embodied in the valve body, and a valve plunger guided in a guide borehole of the valve body, with a valve disk embodied on the valve plunger which can be applied to the valve seat embodied in the valve body to form a seal; wherein an inlet to the check valve is achieved via at least one supply groove embodied in the front side of the valve body opposite the valve seat, and at least one supply borehole embodied in the valve body.

The object can also be achieved by a radial reciprocating pump for high-pressure supply in fuel injection systems of internal combustion engines, comprising a pump housing; and at least one cylinder insert, into which a through-opening forming a cylindrical space is made, into the outer end of which a closure element is fitted which forms a pressure-tight seal of the cylindrical space, with fuel being supplied to the cylindrical space via a fuel supply opening essentially radial to the cylindrical space in the cylinder insert and an intake valve arranged in the through-opening, wherein the intake valve is embodied as a check valve comprising a valve body with a valve seat embodied in the valve body, a valve plunger guided in a guide borehole of the valve body, a valve disk embodied on the valve plunger which can be applied to the valve seat embodied in the valve body to form a seal, an inlet to the check valve formed via at least one supply groove embodied in the front side of the valve body opposite the valve seat, and at least one supply borehole embodied in the valve body.

Two to four, preferably three supply grooves and two to four, preferably three supply boreholes can be embodied in the valve body. Each supply groove may operate in conjunction with at least one supply borehole. The supply grooves can be arranged in a star configuration with equidistant angle spacings to each other. Each supply borehole can be spaced from the guide borehole and the supply borehole may end in an annular area formed by the valve body and the valve plunger above the valve seat. The supply boreholes may run parallel to the valve plunger. The check valve may further comprise a tensioning means which is arranged on the end of the valve plunger opposite the valve disk and a valve spring which is arranged between the valve body and the tensioning means, with the check valve being pretensioned by the valve spring in its closing direction, wherein the tensioning means can be a collar attached by a securing element to the valve plunger. The securing element can be a clamping washer. The valve spring may rest at one end against the collar and at the other end against the valve body.

The invention builds on a generic check valve in that the admission to the check valve is via at least one supply groove embodied in the front side of the valve body opposite the valve seat and via at least one supply borehole formed in the valve body. The advantage of the supply groove over a radial supply borehole is that the valve body is embodied more stably overall, especially in the axial direction. This greatly lessens the danger of the valve body warping, especially if the valve body is caulked into another component. A further advantage of the supply groove lies in the fact that the groove, by contrast with a hole, is significantly simpler to deburr. This reduces manufacturing costs and simplifies the manufacturing process.

An advantageous embodiment of the invention provides for two to four, preferably three supply grooves and two to four, preferably three supply boreholes to be embodied in the valve body. A number of supply grooves or supply boreholes are advantageous to let a sufficiently large volume of liquid pass through the check valve when the valve is fully open. This is not always guaranteed with a single supply groove or supply borehole. In trials three supply grooves or supply boreholes have proved to be especially suitable.

A further advantageous embodiment of the invention makes provision for each supply groove to operate in conjunction with one supply borehole. This guarantees an even flow through the check valve.

In accordance with the invention the supply grooves are preferably arranged in a star configuration at an equidistant angular spacing. The even distribution of the supply grooves ensures an especially even flow through to the check valve. This effectively prevents the flow going to one side of the valve plunger and thereby imposing a strain on it.

A further advantageous embodiment of the invention makes provision for each supply borehole to the spaced from the guide borehole and for the supply borehole to end in an annular area embodied by the valve body and the valve plunger, above the valve seat. The fact that the supply boreholes are spaced from the guide borehole advantageously produces an especially large guide surface since this not, as in the prior art, interrupted by a widened-out area. This means that the valve plunger is guided over a significantly longer area. This guarantees that the valve is guided securely. The secure valve guidance prevents the valve plunger from tilting within the guide borehole, producing an even seating of the valve disk on the valve seat and thus a more secure sealing of the check valve in its closed position.

Especially preferably the supply boreholes run in parallel to the valve plunger. The parallel arrangement of the supply boreholes can be manufactured especially easily. This further reduces the manufacturing costs of the check valve. It is however of course also possible for the supply boreholes to be embodied at any given angle in the valve body, in relation to the axis of the valve plunger.

A further advantageous embodiment of the invention makes provision for a means of tensioning to be arranged at the end of the valve plunger opposite the valve disk and for a valve spring to be provided between the valve body and the means of tensioning, and for the check valve to be pretensioned by the valve spring, with the means of tensioning being a collar attached by a securing element to the valve plunger. The securing of the collar element with the aid of a clamping means on the one hand produces a secure fixing of the collar and on the other an especially simple assembly of the collar on the valve plunger.

In an especially advantageous embodiment of the invention the securing element is a clamping washer. The use of a clamping washer offers the advantage that the clamping washer can be bought in as a standard part. The clamping washer is cheap and thus reduces the manufacturing costs of the check valve. The clamping washers are additionally simple to mount in a groove which is embodied in the valve plunger, which further simplifies the assembly effort.

A further advantageous embodiment of the invention makes provision for the valve spring to rest at one end against the collar and at the other end against the valve body. The supporting of the valve spring, at one end against the collar and at the other end against the valve body, produces an especially simple layout of the check valve and a secure support for the valve spring.

The invention also features a radial reciprocating pump for high-pressure fuel supply for fuel injection systems of internal combustion engines with an inventive intake valve. The inventive intake valve can be simply mounted into a through-borehole embodied as a cylindrical space and fitted with a sealing plug. To this end the check valve with the sealing plug is pressed against a collar of the through borehole embodied as a stepped hole. Warping of the valve body is thus largely excluded in this case because of the robust embodiment of the valve body.

The fact that radial supply openings are replaced by supply grooves produces the particular advantage of a large guide surface for the valve plunger. This guarantees a secure function and a long lifetime for the check valve.

### BRIEF DESCRIPTION OF THE DRAWINGS

Exemplary embodiments and further advantages of the invention are explained below with reference to the drawings. The drawings show the following schematic diagrams:

FIG. 1: a 3D view of an inventive check valve; and

FIG. 2: a detailed view of a radial reciprocating pump with the check valve shown in FIG. 1.

### DETAILED DESCRIPTION

The same components or components with the same function are given the same reference symbols in the text below.

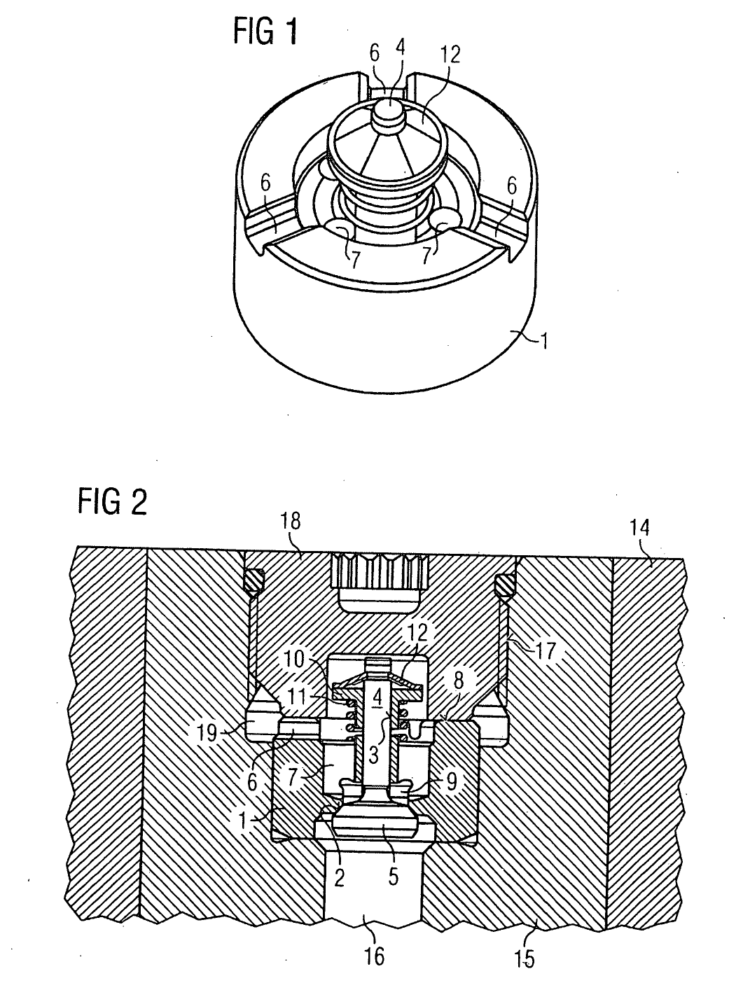

The check valve will be explained below essentially with reference to FIG. 2. The three-dimensional representation of the check valve in FIG. 1 essentially serves in this case to give an idea of the space that it occupies.

FIG. 2 shows a detailed view of a radial reciprocating pump, in particular for high-pressure supply in fuel injection systems of internal combustion engines. The radial reciprocating pump comprises a pump housing 14 and at least one cylinder insert 15 into which a stepped through-opening 17 forming a cylindrical space 16 is introduced. A closure element 18, which forms a pressure-tight seal between the cylindrical space 16 and the environment, is fitted into the radial outer end of the through-opening 17. Fuel is supplied to the cylindrical space 16 via a fuel supply opening 19 essentially radial to the cylindrical space 16 in the cylinder insert 15 and an intake valve 20 arranged in the through-opening 17. The intake valve 20 is pressed via the closure element 18 against a shoulder within the stepped through-opening 17 in the cylinder insert 15 and thereby fixed in the through-opening 17.

The intake valve 20 (see FIG. 1) is embodied as a check valve. It comprises a valve body 1 with a valve seat 2 embodied in the valve body 1 and a valve plunger 4 guided in the guide borehole 3 of the valve body 1, with a valve disk 5 embodied on the valve plunger 4 which can be applied to the valve seat 2 embodied in the valve body 1 to form a seal. The admission 6, 7 to the check valve 20 is via three supply grooves embodied in the front side 8 of the valve body 1 opposite the valve seat 2, and a further via three supply boreholes 7 embodied in the valve body 1. The supply grooves 6 have a rectangular flow cross section. It is however also possible to embody the supply grooves with different flow cross section, for example a semicircular-shape cross-section. The fact that the supply grooves 6 are embodied in the front side 8 of the valve body 1 allows them to be deburred especially easily. It is also particularly easy to make the supply grooves 6, by milling them out for example. Making the supply grooves 6 in the face side 8 of the valve body 1 produces an especially robust valve body 1 which is not weakened by radial supply boreholes and can thus accept higher axial torque forces through den sealing plug 18. There is no danger of the valve body 1 warping, by contrast with the usual valve bodies as demonstrated in the prior art. The three supply grooves 6 are dimensioned in this so that their overall flow cross section at least corresponds to the throughflow cross section of the check valve 20 in the area of the valve seat 2, in the fully open valve position.

For the supply grooves 6, a quantity of three supply grooves 6, arranged in a star configuration with equidistant angular spacing to each other, has proved to be especially advantageous. The star configuration of the three supply grooves 6 produces an especially advantageous supply flow and throughflow in the check valve 20. Naturally it is of course also possible to embody a different number of supply grooves 6 in the front side 8 of the valve body 1.

Each supply groove 6 operates in conjunction with a supply borehole 7. This produces a further improved, especially even throughflow of the check valve 20. The supply boreholes 7 are spaced in this case away from the guide borehole. The spacing of the supply boreholes 7 from the guide borehole 3 produces a continuous, especially long guide borehole 3. This guarantees secure guidance of the valve plunger 4 in the valve body 1. The secure valve plunger guidance guarantees that the valve disk 5 lies evenly on the valve seat 2 embodied in the valve body 1 and that in the closed state a secure seal of the check valve is obtained. As a result of the larger guide surface there is also lower friction and thus a longer lifetime of the check valve 20.

The supply boreholes 7 end in an annular area 9 above the valve seat 2 formed by the valve body 1 and the valve plunger 4. When the check valve 20 is open the liquid can flow from this annular area 9, through the intermediate space between valve body 1 and valve disk 5. The supply boreholes 7 are embodied running in parallel to the valve plunger 4. The parallel embodiment above all offers manufacturing benefits. It is however also possible to embody the through-holes at any angle to the axis of the valve plunger 4 without this impairing the function of the check valve 20.

The check valve 20 features a tensioning means embodied as a collar 10 which is arranged on the end of the valve plunger 4 opposite the valve disk 5. A valve spring 11 is arranged between the collar 10 and the valve body 1. The valve spring 11 pretensions the check valve 20 in its closed position. The collar 10 is secured to the valve plunger 4 by a securing element 12. A clamping washer is used as the securing element 12. The clamping washer 12 is a standard part. The clamping washer 12 is fixed in a groove in the valve plunger 4 in this case. The clamping washer 12 securely prevents the loss of the collar 10. The clamping washer 12 enables the collar 10 to be mounted on the valve plunger 4 in a particularly simple manner. This reduces both the installation time and also the installation costs.

The complete check valve 20 can be pre-installed as a subassembly. This simplifies the assembly of the check valve 20 in the radial reciprocating pump. The inventive check valve 20 is naturally not limited to use in radial reciprocating pumps but can be used for any application requiring a reliable, robust and durable check valve.

To summarize, it can thus be stated that the specific inventive embodiment of the valve body produces an especially stable check valve. The fact that the supply boreholes are spaced away from the guide borehole produces an especially large guide surface which guarantees secure, guidance of the valve plunger and thereby increases the lifetime of the check valve. The check valve is especially suitable for use in radial reciprocating pumps for high-pressure fuel supply in fuel injection systems of internal combustion engines especially for common rail injection systems.

A check valve has a valve body (1) provided with a valve seat (2) formed in the valve body (1), a valve plunger (4) which is guided in a guiding borehole (3) of the valve body (1), and a valve disk (5) which is embodied on the valve plunger (4) and can be applied to the valve seat (2) arranged in the valve body (1) in a sealing manner. The admission (6, 7) to the check valve (1) is carried out by at least one supply groove (6) embodied in the front side (8) of the valve body (1), opposing the valve seat (2), and at least one supply borehole (7) formed in the valve body (1). The check valve (20) is especially suitable for a radial piston pump for the high-pressure supply of fuel in fuel injection systems of internal combustion engines.

What is claimed is:

1. A check valve comprising
a valve body with a valve seat embodied in the valve body; and
a valve plunger guided in a guide borehole of the valve body, with a valve disk embodied on the valve plunger which can be applied to the valve seat embodied in the valve body to form a seal;
wherein
an inlet to the check valve is achieved via
at least one supply groove embodied in the front side of the valve body opposite the valve seat; and
at least one supply borehole embodied in the valve body.

2. A check valve in accordance with claim 1,
wherein
two to four, preferably three supply grooves and two to four, preferably three supply boreholes are embodied in the valve body.

3. A check valve in accordance with claim 1,
wherein
each supply groove operates in conjunction with at least one supply borehole.

4. A check valve in accordance with claim 1,
wherein
the supply grooves are arranged in a star configuration with equidistant angle spacings to each other.

5. A check valve in accordance with claim 1,
wherein
each supply borehole is spaced from the guide borehole and the supply borehole ends in an annular area formed by the valve body and the valve plunger above the valve seat.

6. A check valve in accordance with claim 1,
wherein
the supply boreholes run parallel to the valve plunger.

7. A check valve in accordance with claim 1,
further comprising,
a tensioning means which is arranged on the end of the valve plunger opposite the valve disk and
a valve spring which is arranged between the valve body and the tensioning means, with the check valve being pretensioned by the valve spring in its closing direction,
wherein
the tensioning means is a collar attached by a securing element to the valve plunger.

8. A check valve in accordance with claim 7,
wherein
the securing element is a clamping washer.

9. A check valve in accordance with claim 7,
wherein
the valve spring rests at one end against the collar and at the other end against the valve body.

10. A radial reciprocating pump for high-pressure supply in fuel injection systems of internal combustion engines, comprising:
a pump housing; and
at least one cylinder insert, into which a through-opening forming a cylindrical space is made, into the outer end of which a closure element is fitted which forms a pressure-tight seal of the cylindrical space,
wherein fuel being supplied to the cylindrical space via a fuel supply opening essentially radial to the cylindrical space in the cylinder insert and an intake valve arranged in the through-opening,
and wherein
the intake valve is embodied as a check valve comprising a valve body with a valve seat embodied in the valve body, a valve plunger guided in a guide borehole of the valve body, a valve disk embodied on the valve plunger which can be applied to the valve seat embodied in the valve body to form a seal, an inlet to the check valve formed via at least one supply groove embodied in the front side of the valve body opposite the valve seat, and at least one supply borehole embodied in the valve body.

11. A pump in accordance with claim 10, wherein
two to four, preferably three supply grooves and two to four, preferably three supply boreholes are embodied in the valve body.

12. A pump in accordance with claim 10, wherein
each supply groove operates in conjunction with at least one supply borehole.

13. A pump in accordance with claim 10, wherein
the supply grooves are arranged in a star configuration with equidistant angle spacings to each other.

14. A pump in accordance with claim 10, wherein
each supply borehole is spaced from the guide borehole and the supply borehole ends in an annular area formed by the valve body and the valve plunger above the valve seat.

15. A pump in accordance with claim 10, wherein
the supply boreholes run parallel to the valve plunger.

16. A pump in accordance with claim 10, further comprising,
a tensioning means which is arranged on the end of the valve plunger opposite the valve disk and
a valve spring which is arranged between the valve body and the tensioning means, with the check valve being pretensioned by the valve spring in its closing direction,
wherein
the tensioning means is a collar attached by a securing element to the valve plunger.

17. A pump in accordance with claim 10, wherein
the securing element is a clamping washer.

18. A pump in accordance with claim 10, wherein
the valve spring rests at one end against the collar and at the other end against the valve body.

19. A check valve comprising
a valve body comprising a valve seat;
a valve plunger guided in a guide borehole of the valve body,
a valve disk embodied on the valve plunger which can be applied to the valve seat embodied in the valve body to form a seal;
an inlet to the check valve formed via at least one supply groove embodied in the front side of the valve body opposite the valve seat, adapt least one supply borehole embodied in the valve body,
a tensioning means which is arranged on the end of the valve plunger opposite the valve disk, and
a valve spring which is arranged between the valve body and the tensioning means, with the check valve being pretensioned by the valve spring in its closing direction.

20. A check valve in accordance with claim 19, wherein the tensioning means is a collar attached by a securing element to the valve plunger.
